(19) United States
(12) Patent Application Publication
(10) Pub. No.: US 2008/0252537 A1
(43) Pub. Date: Oct. 16, 2008

(54) THROUGH-GLASS ANTENNA SYSTEM

(75) Inventor: ARGY PETROS, PARKLAND, FL (US)

Correspondence Address: AKERMAN SENTERFITT, P.O. BOX 3188, WEST PALM BEACH, FL, 33402-3188, US

(73) Assignee: THINK WIRELESS, INC., PARKLAND, FL (US)

(21) Appl. No.: 11/733,593

(22) Filed: Apr. 10, 2007

(51) Int. Cl. H01Q 1/32; H01Q 1/36

(52) U.S. Cl. 343/713; 343/700 MS

(57) ABSTRACT

A through-glass antenna system (10) includes a patch antenna (14) mounted on a horizontal flat surface (51) of a three-dimensional conductive structure (16). The structure can serve as a ground plane for the patch antenna and further include bent and folded sides (52, 54, and 56) where one side includes a conductive surface (52) that extends below the horizontal flat surface and if necessary further bends at an approximate angle of a vehicle's front or rear window (30), a substantially planar external coupler (26) having an inside portion (63) and an edge portion (67) where the patch antenna is connected to the inside portion (63) of the external coupler, a substantially planar internal coupler (32) having an inside portion (7)3 and an edge portion (77), and a low noise amplifier (36) where the low noise amplifier is connected to the edge portion of the internal coupler.

### FIELD

This invention relates generally to through-glass antennas, and more particularly to through-glass antenna system suitable for satellite and terrestrial signals.

### BACKGROUND

Satellite digital audio radio service (SDARS) is a satellite broadcast service recently approved by the U.S. Federal Communications Commission (FCC) which provides satellite transmission of digital audio programs to compatible radio receivers. The radio receivers can be stationary or mobile and are generally configured to receive signals from satellites as well as terrestrial repeaters.

Automotive satellite radio antennas are small patch antennas that are magnetically attached to the top of the roof and connected to the radio through an radio frequency (RF) coaxial cable. The RF coaxial cable is routed from the exterior to the interior of the automobile. This becomes a cumbersome task that results in a cosmetically and mechanically poor solution. Furthermore, water can transfer from the exterior of the vehicle to the interior. Also, due to warranty concerns, drivers of leased vehicles do not prefer the magnetic antenna attached to the roof as it may cause scratches and discoloration to the exterior of the vehicle. Although existing through-glass antennas for reception of a combination of satellite and terrestrial signals are capable of coupling through-glass without drilling holes to the exterior of the automobile body, such existing antenna systems fail to provide a system utilizing a single transmission line that is routed from the exterior to the interior of the automobile.

Magnetic patch antennas, when placed at a proper location on a vehicle roof, have acceptable gain at the horizon (for receiving TER signals) and acceptable gain between 20 and 90-degree elevation angles (for receiving SAT signals), but any glass mounted antenna having similar performance as a roof antenna is typically much larger and unduly complicated with additional transmission lines, structures, and elements that adds costs to the overall system.

Through-glass couplers, as explained in U.S. Pat. No. 5,565,877 to Du et al., are employed to RF couple two antenna modules that are mounted, respectively, on the outside and inside surfaces of window glass, such as automobile glass, to transmit signals through the window glass between the opposing coupling modules. The outside antenna module might include a vertically extending antenna element, while the inside antenna module typically contains a connector or transmission feedline, which leads to a device such as a telephone, pager, facsimile machine, radio receiver, or the like, inside the vehicle. In a radio receiver implementation, the inside antenna module receives RF energy through the glass from the outside antenna module.

U.S. Pat. No. 7,091,915 to Truthan et al., discusses a through glass antenna system that uses two pairs of couplers and antennas to couple satellite and terrestrial signals from the outside to the inside of the vehicle. The system of Truthan et al. includes first and second interior couplers and an first and second exterior couplers where the first interior coupler is configured to be mounted on the interior surface of the dielectric panel in approximate juxtaposition with the first exterior coupler module and where the second interior coupler is configured to be mounted on the interior surface of the dielectric panel in approximate juxtaposition with the second exterior coupler module. The two pairs of couplers are needed for adequate performance for both the received satellite signals and the received terrestrial signals.

### SUMMARY

Embodiments in accordance with the present invention can provide a through-glass antenna system that uses a single pair of coupler elements to provide adequate performance for received satellite signals as well as for received terrestrial signals.

In a first embodiment of the present invention, a through-glass antenna system can include a patch antenna, a three-dimensional conductive structure having a horizontal flat surface serving as a ground plane for the patch antenna and further including bent and folded sides where one side includes a conductive surface that extends below the horizontal flat surface and if necessary further bends at an approximate angle of a vehicle's front or rear window or other glass surface, a substantially planar external coupler having an inside portion and an edge portion where the patch antenna is connected to the inside portion of the external coupler, a substantially planar internal coupler having an inside portion and an edge portion, and a low noise amplifier where the low noise amplifier is connected to the edge portion of the internal coupler. Similarly, the system can alternatively include a substantially planar external coupler having an edge portion where the patch antenna is connected to the edge portion of the external coupler, a substantially planar internal coupler having an inside portion and an edge portion, and a low noise amplifier where the low noise amplifier is connected to the inside portion of the internal coupler. As the external and internal couplers are positioned opposite to each other, the substantially planar internal coupler and the substantially planar external coupler couple to each other wirelessly on opposing sides of a vehicle windshield or glass. The horizontal flat surface can be ½ wavelength or less in size, serving as a platform for the patch antenna and the horizontal flat surface can further include a through-hole for a feed point attachment from the patch antenna to a center conductor of a coaxial transmission line. The surrounding walls of the platform can extend down away from the patch antenna at about ¼ wavelength or less in size. The surrounding walls can be cut at an angle to correlate to the approximate angle of a vehicle's front or rear window to maintain a horizontal orientation of the patch antenna. The system can further include a transmission line directly coupling the patch antenna to the inside portion of the external coupler and a transmission line directly coupling the low noise amplifier with the edge portion of the internal coupler.

The patch antenna, the three-dimensional conductive structure, and the substantially planar external coupler can form an external coupler module and the substantially planar internal coupler and the low noise amplifier can form an internal coupler module. The system can further include a radome covering the external coupler module. The three-dimensional conductive structure can have a wall having a metallic piece that extends under the horizontal flat surface at an approximate angle of a vehicle's front or rear window or other glass surface to make the wall effectively equal the length of a longest wall of the three-dimensional conductive structure. Note, the patch antenna can be a ceramic or microstrip patch antenna and the three dimensional conductive structure can be a metallic structure formed from a single piece of metal or from a plurality of pieces of metal soldered, welded or taped together. Alternatively, the three dimensional conductive structure can be formed from a three dimensional substrate having metallization or plating thereon. Further note, the system can provide a minimum of 2 dBi gain performance for satellite signals received and a minimum of −3 dBi gain performance for terrestrial signals received. In other words, the system provides acceptable gain performance for both received satellite signals and received terrestrial signals substantially along a horizon.

In a second embodiment of the present invention, a through-glass antenna system can include a patch antenna, a three-dimensional conductive structure having a horizontal flat surface serving as a ground plane for the patch antenna and further including bent and folded sides where one side includes a conductive surface that extends below the horizontal flat surface and if necessary further bends at an approximate angle of a vehicle's front or rear window or other glass surface, a substantially planar external coupler, a substantially planar internal coupler; and a low noise amplifier where the low noise amplifier is connected to the internal coupler and where the system provides acceptable gain performance for both received satellite signals and received terrestrial signals substantially along a horizon. The substantially planar external coupler can have an inside portion and an edge portion and the patch antenna can be connected to the inside portion of the external coupler and where the substantially planar internal coupler has an inside portion and an edge portion and the low noise amplifier can be connected to the edge portion of the internal coupler. The system can further include a transmission line directly coupling the patch antenna to the inside portion of the external coupler and a transmission line directly coupling the low noise amplifier with the edge portion of the internal coupler. The three-dimensional conductive structure can include a wall having a metallic piece that extends under the horizontal flat surface at an approximate angle of a vehicle's front or rear window to make the wall effectively equal the length of a longest wall of the three-dimensional conductive structure.

In a third embodiment of the present invention, a through-glass antenna system can include a patch antenna, a three-dimensional conductive structure having a horizontal flat surface serving as a ground plane for the patch antenna and further including bent and folded sides wherein one side includes a conductive surface that extends below the horizontal flat surface and if necessary further bends at an approximate angle of a vehicle's front or rear window, a substantially planar external coupler, a substantially planar internal coupler, and a low noise amplifier, wherein the low noise amplifier is connected to the internal coupler and where the system provides a minimum of +2 dBi gain performance for satellite signals received and a minimum of −3 dBi gain performance for terrestrial signals received. The system can provide acceptable gain performance for both received satellite signals and received terrestrial signals substantially along a horizon.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an exploded view of a through-glass antenna system in accordance with an embodiment of the present invention.

FIG. 2 is an illustration of a vehicle having an antenna system in accordance with an embodiment of the present invention.

FIG. 3 is a perspective view of an external antenna module in accordance with an embodiment of the present invention.

FIG. 4 is a side view of the external antenna module of FIG. 3 in accordance with an embodiment of the present invention.

FIG. 5 is a plan view of an external coupler element in accordance with an embodiment of the present invention.

FIG. 6 is a plan view of an internal coupler element in accordance with an embodiment of the present invention.

FIG. 7 is an exploded view of an alternative through-glass antenna system in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways that can enable an antenna system to adequately receive satellite signals and terrestrial signals using a single pair of coupler elements.

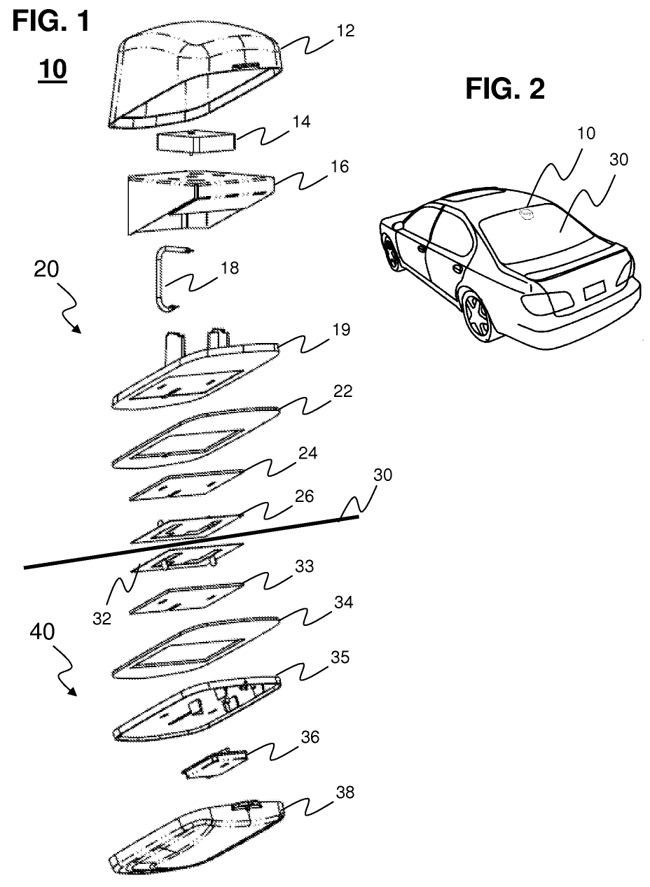

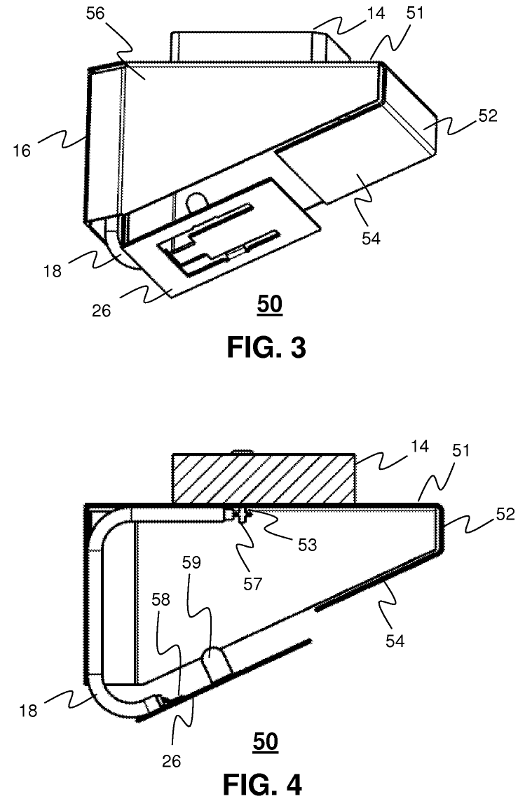

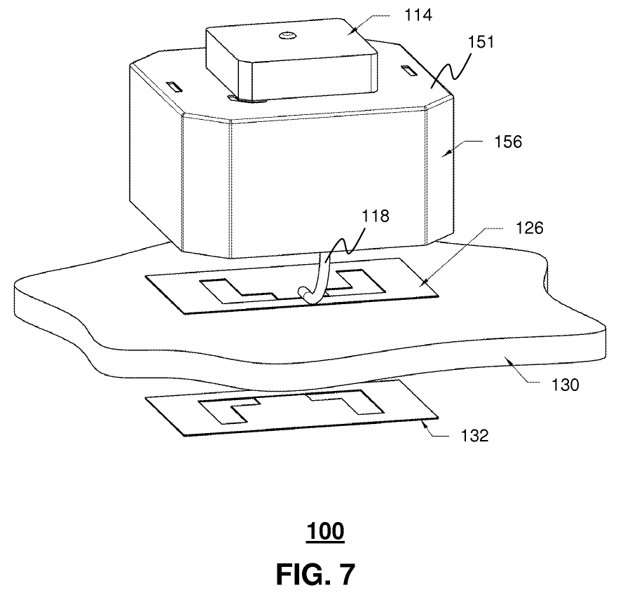

Referring to FIGS. 1-6, a through-glass antenna system 10 can include a patch antenna 14 mounted on a substantially planar surface or a horizontal flat surface 51 of a three-dimensional conductive structure 16. The substantially planar surface can have a planar surface dimension between 0.25 and 0.5 wavelengths and serves as a platform for a patch antenna 14. Further note, surrounding walls of the platform can extend down away from the patch antenna 14 at about 0.25 wavelengths or less in size. The structure 16 can serve as a ground plane for the patch antenna and include bent and folded sides (see items 52, 54, and 56 of FIG. 3) where one side includes a conductive surface 52 that extends below the horizontal flat surface 51 and further bends at an approximate angle of a vehicle's front or rear window 30, a substantially planar external coupler 26 (see FIGS. 3-5) having an inside portion 63 and an edge portion 67 where the patch antenna 14 is connected to the inside portion 63 of the external coupler 26 via coaxial cable 18, a substantially planar internal coupler 32 (see FIGS. 1 and 6) having an inside portion 73 and an edge portion 77, and a low noise amplifier 36 where the low noise amplifier 36 is connected to the edge portion 77 of the internal coupler 32 via coaxial cable 78. The substantially planar internal coupler 32 and the substantially planar external coupler 26 couple to each other wirelessly on opposing sides of a vehicle windshield or glass or other dielectric surface 30. The horizontal flat surface 51 can be ½ wavelength (of the received satellite signal) or less in size, serving as a platform for the patch antenna 14 and the horizontal flat surface 51 can further include a through-hole 53 (see FIG. 4) for a feed point attachment 57 from the patch antenna 14 to a center conductor of a coaxial transmission line 18. The surrounding walls 52, 54, and 56 of the platform (51) can extend down away from the patch antenna 14 at about ¼ wavelength or less in size. The surrounding walls can be cut at an angle to correlate to the approximate angle of a vehicle's front or rear window to maintain a horizontal orientation of the patch antenna 14. As noted, the system in accordance with the embodiments can be design to correlate to the approximate angle of the vehicle's window, which can even include an angle of zero to accommodate a flat glass roof for example as illustrated in the embodiment of FIG. 7. The system 10 can further include a transmission line 18 directly coupling the patch antenna 14 to the inside portion 63 of the external coupler 26 and a transmission line 78 directly coupling the low noise amplifier 36 with the edge portion 77 of the internal coupler 32.

The patch antenna 14, the three-dimensional conductive structure 16, and the substantially planar external coupler 26 can form an external coupler module 20, whereas the substantially planar internal coupler 32 and the low noise amplifier 36 can form an internal coupler module 40. The system 10 can further include a radome 12 covering the external coupler module 20. The external coupler module 20 can further include an appropriate plastic support member 19, and adhesive tape portions 22 and 24 as shown in FIG. 1. The internal coupler module 40 can further include adhesive tape portions 33 and 34 as well as a plastic support member 35 and a plastic cover 38 for encasing the low-noise amplifier 36.

Referring again to FIGS. 3 and 4, an assembly 50 can include the three-dimensional conductive structure 16, the patch antenna 14 and the external coupler 26. The structure 16 can have a wall 52 having a metallic piece 54 that extends under the horizontal flat surface 51 at an approximate angle of a vehicle's front or rear window to make the wall (52 and 54 combined) effectively equal the length of a longest wall of the three-dimensional conductive structure 16. Note, the patch antenna 14 can be a ceramic patch antenna and the three dimensional conductive structure 16 can be a metallic structure formed from a single piece of metal or from a plurality of pieces of metal soldered, welded or taped together using copper tape for example. Alternatively, the three dimensional conductive structure 16 can be formed from a three dimensional substrate having metallization or plating thereon. The couplers (26 and 32) can also include protruding members or tabs 59 that aid in alignment of the various elements of the system 10. Further note, the system can provide a minimum of +2 dBi gain performance for satellite signals received and a minimum of −3 dBi gain performance for terrestrial signals received. In other words, the system 10 provides acceptable gain performance for both received satellite signals and received terrestrial signals substantially along a horizon.

The ground plane for the system 10 can be the structure 16 which can be a metallic piece with a flange or skirt along each edge facing away from the patch antenna 14 at an approximate 90-degree angle to the piece. The structure can include a feed-through hole 53 in the flat horizontal surface 51 of the ground plane to enable a physical antenna connection using for example a center conductor of coaxial transmission line 18. The flanges can be cut at an angle to match the vehicle windshield screen angle in order to maintain a horizontal orientation of the top surface of the ground plane. The shortest flange can have a minimum vertical length of ¼ inch. The flanges can be continuous and connected at the corners through mechanical means such as solder, welding or copper tape as previously noted. The ground plane can be fabricated by mechanical means, as a drawn or stamped-out metal can or by plating a composite substrate material or vacuum metallizing a composite substrate material.

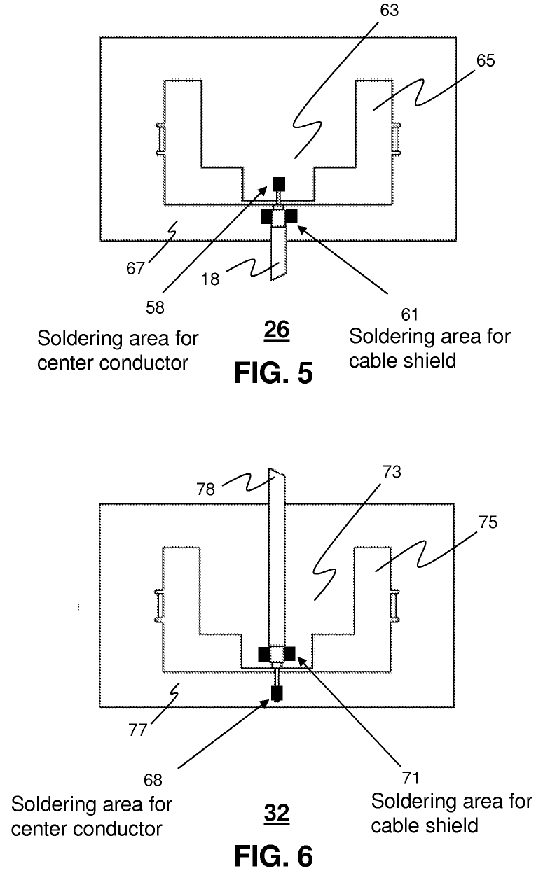

The manner in which the coupler elements 26 and 32 are attached to other components in the system can also provide enhanced performance as can be further seen with respect to FIGS. 5 and 6. Note, the external coupler 26 can include a cut-out area 65 forming an inside portion 63 having a soldering area 58 and an edge portion 67 having a soldering area 61. Likewise, the internal coupler 32 can include a cut-out area 75 forming an inside portion 73 having a soldering area 71 and an edge portion 77 having a soldering area 68. Referring to the external coupler 26 in FIG. 5, the patch antenna 14 (not shown here) can be coupled to the external coupler 26 via a coaxial transmission line 18 where the center conductor is coupled to the inside portion 63 at the soldering area 58. A cable shield for the coaxial transmission line 18 can be soldered to the edge portion 67 at the soldering area 61. Referring to the internal coupler 32 in FIG. 6, the low-noise amplifier 36 (not shown here) can be coupled to the internal coupler 32 via a coaxial transmission line 78 where the center conductor is coupled to the edge portion 77 at the soldering area 68. A cable shield for the coaxial transmission line 78 can be soldered to the inside portion 73 at the soldering area 71.

The embodiment shown can have a top flat horizontal surface or a substantially planar surface or flat ground plane of dimensions between ¼ and ½ wavelength, fabricated by mechanical means with a 1-inch flange under the front face cut at an angle to correlate to the approximate angle of a vehicle windshield screen. Note, the substantially planar surface is arrange or constructed to become horizontal after mounting on a vehicle window. Of course, the dimensions and shapes are not necessarily limited to those described, but may be limited in performance. Nonetheless, other embodiments may include a domed, dished, elliptical, round or polyshaped ground plane. Further note that antenna gain requirements for one satellite radio service provider might be different from another satellite radio service provider due to their satellite infrastructure configuration. One such system may require gain at relatively low satellite elevation angles, e.g., 20-30 degrees from the horizon, and gain along the horizon for optimum terrestrial signal reception. The structure described herein causes an increase in antenna gain at low elevation angles using a single pair of couplers suitable for both satellite radio reception and terrestrial signal reception. The embodiments herein are simple in terms of manufacture and assembly and do not need placement of couplers in juxtaposition to each other.

As previously noted, the embodiments can accommodate a flat glass surface on a vehicle as illustrated in the antenna a through-glass antenna system 100 of FIG. 7 which can include a patch antenna 114 mounted on a substantially planar surface or a horizontal flat surface 151 of a three-dimensional conductive structure 156. As in other embodiments, the substantially planar surface 151 can have a planar surface dimension between 0.25 and 0.5 wavelengths and serves as a platform for the patch antenna 114. Further note, surrounding walls of the platform can extend down away from the patch antenna 114 at about 0.25 wavelengths or less in size. The structure 156 can serve as a ground plane for the patch antenna 114 and include bent and folded sides where one side includes a conductive surface that extends below the horizontal flat surface 151 and can further bend (if needed) at an approximate (zero) angle of the surface of a vehicle's flat window 130, a substantially planar external coupler 126 where the patch antenna 114 is connected to external coupler 126 via coaxial cable 118, and a substantially planar internal coupler 132. Note, the structure 156 can have walls that bend down from the horizontal flat surface 151 and no corresponding parallel wall below that would be parallel to surface 151. Of course, the structure 156 can also include a corresponding parallel wall below surface 151 that can be of any particular dimension as needed for a particular design. Either way, such a structure accommodates a flat glass surface and maintains a flat ground plane. The bent sides can be of approximate length of 0.25 wavelengths or less. In one particular embodiment, the bent sides can be 1 inch (or approximately 0.2 wavelengths). The substantially planar internal coupler 132 and the substantially planar external coupler 126 couple to each other wirelessly on opposing sides of the vehicle windshield or glass or other dielectric surface 130. Metallic structure 156 can also be just a planar metallic surface without walls. This results in higher antenna gain and higher elevation angles and lower antenna gain at lower elevation angles and along the horizon.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A through-glass antenna system, comprising:
a patch antenna;
a three-dimensional conductive structure having a substantially planar surface serving as a ground plane for the patch antenna and further including bent and folded sides wherein one side includes a conductive surface that extends below the substantially planar surface and further bends at an approximate angle of a vehicle's front or rear window;
a substantially planar external coupler having an inside portion and an edge portion, wherein the patch antenna is connected to the external coupler;
a substantially planar internal coupler having an inside portion and an edge portion, wherein the couplers are positioned opposite to each other; and
a low noise amplifier, wherein the low noise amplifier is connected to the internal coupler.

2. The through glass antenna system of claim 1, wherein the substantially planar internal coupler and the substantially planar external coupler couple to each other wirelessly on opposing sides of a vehicle windshield.

3. The through glass antenna system of claim 1, wherein the substantially planar surface has a planar surface dimension between 0.25 and 0.5 wavelengths and serves as a platform for the patch antenna.

4. The through glass antenna system of claim 3, wherein the horizontal flat surface further includes a through-hole for a feed point attachment from the patch antenna to a center conductor of a coaxial transmission line.

5. The through glass antenna system of claim 3, wherein surrounding walls of the platform extend down away from the patch antenna at about 0.25 wavelengths or less in size.

6. The through glass antenna system of claim 5, wherein the surrounding walls are cut at an angle to correlate to the approximate angle of a vehicle's front or rear window to maintain horizontal orientation of the patch antenna.

7. The through glass antenna system of claim 1, wherein the system further comprises a transmission line directly coupling the patch antenna to the inside portion of the external coupler and a transmission line directly coupling the low noise amplifier with the edge portion of the internal coupler.

8. The through glass antenna system of claim 1, wherein the patch antenna, the three-dimensional conductive structure, and the substantially planar external coupler forms an external coupler module and the substantially planar internal coupler and the low noise amplifier forms an internal coupler module.

9. The through glass antenna system of claim 8, wherein the system further comprises a radome covering the external coupler module.

10. The through glass antenna system of claim 8, wherein the three-dimensional conductive structure comprises a wall having a metallic piece that extends under the planar surface at an approximate angle of a vehicle's front or rear window to make the wall effectively equal the length of a longest wall of the three-dimensional conductive structure.

11. The through glass antenna system of claim 1, wherein the patch antenna is a ceramic patch antenna and the three dimensional conductive structure is a metallic structure formed from a single piece of metal or from a plurality of pieces of metal soldered, welded or taped together.

12. The through glass antenna system of claim 1, wherein the three dimensional conductive structure is formed from a three dimensional substrate having metallization or plating thereon.

13. The through glass antenna system of claim 1, wherein the system provides a minimum of +2 dBi gain performance for satellite signals received and a minimum of −3 dBi gain performance for terrestrial signals received.

14. The through glass antenna system of claim 1, wherein the system provides acceptable gain performance for both received satellite signals and received terrestrial signals substantially along a horizon.

15. A through-glass antenna system, comprising:
a patch antenna;
a three-dimensional conductive structure having a horizontal flat surface serving as a ground plane for the patch antenna and further including bent and folded sides wherein one side includes a conductive surface that extends below the horizontal flat surface and further bends at an approximate angle of a vehicle's front or rear window;
a substantially planar external coupler;
a substantially planar internal coupler; and
a low noise amplifier, wherein the low noise amplifier is connected to the internal coupler and wherein the system provides acceptable gain performance for both received satellite signals and received terrestrial signals substantially along a horizon.

16. The through-glass antenna system of claim 15, wherein the substantially planar external coupler has an inside portion and an edge portion and the patch antenna is connected to the inside portion of the external coupler and wherein the substantially planar internal coupler has an inside portion and an edge portion and the low noise amplifier is connected to the edge portion of the internal coupler.

17. The through glass antenna system of claim 16, wherein the system further comprises a transmission line directly coupling the patch antenna to the inside portion of the external coupler and a transmission line directly coupling the low noise amplifier with the edge portion of the internal coupler.

18. The through glass antenna system of claim 15, wherein the three-dimensional conductive structure comprises a wall having a metallic piece that extends under the horizontal flat surface at an approximate angle of a vehicle's front or rear window to make the wall effectively equal the length of a longest wall of the three-dimensional conductive structure.

19. A through-glass antenna system, comprising:
a patch antenna;
a three-dimensional conductive structure having a horizontal flat surface serving as a ground plane for the patch antenna and further including bent sides that extend below the horizontal flat surface;
a substantially planar external coupler;
a substantially planar internal coupler; and
a low noise amplifier, wherein the low noise amplifier is connected to the internal coupler and wherein the system provides acceptable gain performance for both received satellite signals and received terrestrial signals substantially along a horizon.

20. A through-glass antenna system, comprising:
a patch antenna;
a three-dimensional conductive structure having a horizontal flat surface serving as a ground plane for the patch antenna and further including bent and folded sides wherein one side includes a conductive surface that extends below the horizontal flat surface and further bends at an approximate angle of a vehicle's front or rear window;
a substantially planar external coupler;
a substantially planar internal coupler; and
a low noise amplifier, wherein the low noise amplifier is connected to the internal coupler and wherein the system provides a minimum of +2 dBi dB gain performance for satellite signals received and a minimum of −3 dBi dB gain performance for terrestrial signals received.

21. The through glass antenna system of claim 19, wherein the system provides acceptable gain performance for both received satellite signals and received terrestrial signals substantially along a horizon.
